(19) United States
(12) Patent Application Publication
(10) Pub. No.: US 2026/0163184 A1
(43) Pub. Date: Jun. 11, 2026

(54) SECONDARY BATTERY

(71) Applicant: SK On Co., Ltd., Seoul (KR)

(72) Inventors: Won Je OH, Daejeon (KR); Moon Hyung JUNG, Daejeon (KR)

(21) Appl. No.: 19/342,675

(22) Filed: Sep. 29, 2025

(30) Foreign Application Priority Data
Dec. 5, 2024 (KR) 10-2024-0179210

(51) Int. Cl. H01M 50/466; H01M 10/04; H01M 50/536; H01M 50/538

(52) U.S. Cl. CPC H01M 50/466; H01M 10/0422; H01M 10/0431; H01M 50/536; H01M 50/538

(57) ABSTRACT

A secondary battery is disclosed. According to one aspect of the present disclosure, there is provided a secondary battery including a can and an electrode assembly which is accommodated inside the can and includes first and second electrode sheets disposed with a separator interposed therebetween that are wound around a central axis, wherein the separator includes an overlap region at one or both end portion regions in a central axis direction.

### CROSS-REFERENCE TO RELATED APPLICATION

This application claims priority to and the benefit of Korean Patent Application No. 10-2024-0179210, filed on December 5, 2024, the disclosure of which is incorporated herein by reference in its entirety.

### BACKGROUND

### 1. Field of the Invention

Embodiments of the present disclosure relate to a secondary battery.

### 2. Discussion of Related Art

A secondary battery is one of the energy storage means which can be charged and discharged through electrochemical reactions. The secondary battery may be utilized in various fields in which electrical energy is used. For example, secondary batteries are widely utilized in the field of mobile devices such as a cell phone, a notebook, a tablet, and the like, and are being explored for wider utilization in the field of transportation means such as vehicles, aircraft, ships, and the like. Further, demand for secondary batteries is increasing in the field of energy storage systems (ESSs) for utilizing surplus electricity.

Secondary batteries can be classified into pouch types, prismatic types, cylindrical types, and coin types depending on the packaging type. Among these, cylindrical secondary batteries have advantages such as standardized size and convenience of mass production, and recently, demand for the cylindrical secondary batteries has been rapidly increasing in the vehicle field. Meanwhile, some cylindrical secondary batteries have a tabless structure in which a lead tab is omitted. The tabless structure may secure a larger conductive area than the lead tab method, thereby effectively functioning to reduce resistance, heat generation, and the like.

### SUMMARY OF THE INVENTION

Embodiments of the present disclosure are directed to providing a secondary battery.

In addition, some embodiments of the present disclosure are directed to providing a secondary battery having a tabless structure in which a lead tab is omitted.

In addition, some embodiments of the present disclosure are directed to providing a secondary battery capable of preventing damage to a separator during a manufacturing process or use.

In addition, some embodiments of the present disclosure are directed to providing a secondary battery capable of maintaining convenience in manufacturing or processing.

Some embodiments of the present disclosure may be widely applied in the field of green technologies such as an electric vehicle and a battery charging station as well as solar power generation and wind power generation using batteries. Further, some embodiments of the present disclosure may be used in an eco-friendly electric vehicle, a hybrid vehicle, and the like to prevent climate change by suppressing air pollution and greenhouse gas emissions.

According to an aspect of the present disclosure, there is provided a secondary battery including a can and an electrode assembly which is accommodated inside the can and includes first and second electrode sheets disposed with a separator interposed therebetween that are wound around a central axis, wherein the separator includes an overlap region at one or both end portion regions in a direction of the central axis.

In some embodiments, the overlap region may be provided by folding a portion of the separator in the end portion region.

In some embodiments, the overlap region may be provided by folding a portion of the separator along a transverse folding line perpendicular to the central axis.

In some embodiments, the overlap region may be provided by bonding the folded portion of the separator to another portion of the separator.

In some embodiments, the overlap region may be formed by overlapping a portion of the separator in a plurality of overlapping layers in a thickness direction in the end portion region.

In some embodiments, the overlap region may be disposed between an electrode tab provided in one end portion region of the first electrode sheet and one end portion of the second electrode sheet.

In some embodiments, the overlap region may be provided to be bent toward one end portion of the second electrode sheet to cover the end portion.

In some embodiments, the overlap region may be provided such that a portion of the separator is folded radially inward or radially outward in the end portion region.

In some embodiments, the overlap region may be provided such that a portion of the separator is continuously folded radially inward or radially outward a plurality of times in the end portion region.

In some embodiments, the overlap region may be provided such that a portion of the separator is alternately and repeatedly folded radially inward or radially outward in the end portion region.

In some embodiments, the overlap region may include cutting lines at predetermined intervals in a winding direction around the central axis.

In some embodiments, the can may be provided in a cylindrical shape with a predetermined diameter and height.

In some embodiments, the electrode assembly may include a bonding surface at one or both end portions along the central axis direction, and the bonding surface may be provided with a plurality of electrode tabs disposed in a circumferential direction and bent toward the central axis.

In some embodiments, the bonding surface may be welded to a current collector or a cap plate.

In some embodiments, the first electrode sheet or the second electrode sheet may include a metal foil wound around the central axis, an active material provided on at least one surface of the metal foil, and a plurality of electrode tabs provided in one end portion region of the metal foil in the central axis direction and bent toward the central axis.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic perspective view of a secondary battery according to one embodiment of the present disclosure;

FIG. 2 is a schematic perspective view of an electrode assembly according to one embodiment of the present disclosure;

FIG. 3 is a view schematically illustrating a state in which the electrode assembly of FIG. 2 is wound around a central axis;

FIG. 4 is a view illustrating a state in which electrode tabs at upper and lower ends in the wound electrode assembly illustrated in FIG. 3 have undergone a flattening process;

FIG. 5 is a schematic view illustrating an enlarged upper end portion of the electrode assembly illustrated in FIG. 3;

FIG. 6 is a schematic view illustrating a state in which an electrode tab in the electrode assembly illustrated in FIG. 5 is bent;

FIG. 7 is a schematic view illustrating another embodiment of the separator illustrated in FIG. 5;

FIG. 8 is a schematic view illustrating still another embodiment of the separator illustrated in FIG. 5; and

FIG. 9 is a schematic view illustrating yet another embodiment of the separator illustrated in FIG. 5.

### DETAILED DESCRIPTION OF EXEMPLARY EMBODIMENTS

Hereinafter, the present disclosure will be described in detail with reference to the accompanying drawings. However, this is merely exemplary, and the present disclosure is not limited to the exemplified specific embodiments.

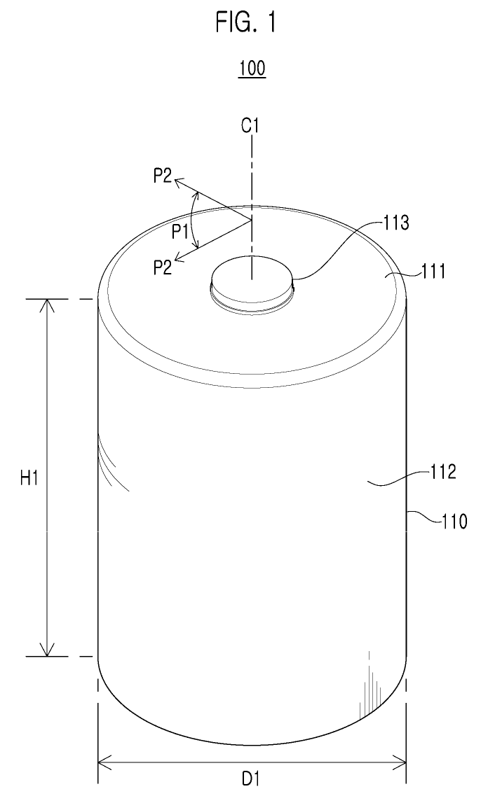

FIG. 1 is a schematic perspective view of a secondary battery according to one embodiment of the present disclosure.

Hereinafter, for convenience, a P1 direction will be referred to as a circumferential direction, a P2 direction will be referred to as a radial direction, and a C1 direction will be referred to as a vertical direction based on a central axis C1 illustrated in FIG. 1.

Referring to FIG. 1, in some embodiments, a secondary battery 100 may include a can 110. The can 110 may form an inner space in which an electrode assembly 120 is accommodated. In some embodiments, the can 110 may have an upper surface 111 and a side surface 112 and may have a cylindrical shape with an open lower portion. Although not illustrated, an opening at the lower portion of the can 110 may be provided to be appropriately closed by a cap plate or the like.

In some embodiments, a rivet 113 may be provided on the upper surface 111 of the can 110. The rivet 113 may function as one electrode terminal. For example, the rivet 113 may function as a positive electrode terminal. In the above, the remaining region of the can 110 excluding the rivet 113 may function as the other electrode terminal corresponding to the rivet 113. For example, the remaining region of the upper surface 111 of the can 110 excluding the rivet 113 may function as a negative electrode terminal. In some embodiments, a gasket for electrical insulation and mechanical sealing may be provided between the rivet 113 and the can 110.

In some embodiments, the can 110 may be provided in a cylindrical shape having a predetermined diameter D1 and height H1. In other words, the secondary battery 100 may be provided in the cylindrical shape having the predetermined diameter D1 and height H1. For example, the secondary battery 100 may have a diameter of 46 mm and a height of 80 mm. In some cases, the secondary battery 100 having such a form factor may be referred to as a '4680 battery.' As another example, the secondary battery 100 may have a diameter of 46 mm and a height of 80 mm, a diameter of 46 mm and a height of 95 mm, or a diameter of 46 mm and a height of 110 mm. In some cases, the secondary battery 100 having such a form factor may be referred to as a '46xx battery.' In the '46xx', 'xx' may describe a height of the corresponding form factor. As still another example, the secondary battery 100 may have a diameter of 48 mm and a height of 75 mm, a diameter of 48 mm and a height of 80 mm, or a diameter of 48 mm and a height of 110 mm. In some cases, the secondary battery 100 having such a form factor may be referred to as a '48xx battery.' In the '48xx', 'xx' may describe a height of the corresponding form factor. However, in the present disclosure, the diameter D1 and height H1 of the secondary battery 100 may be variously changed, and are not necessarily limited to those exemplified above.

Meanwhile, although a cylindrical secondary battery 100 is illustrated in the present description, the form factor of the secondary battery 100 according to the embodiments of the present disclosure is not necessarily limited to the exemplified cylindrical type. The secondary battery 100 according to the embodiments of the present disclosure may be variously implemented or applied as a coin type, a prismatic type, a pouch type, or other atypical shapes within the range including the technical idea to be described below.

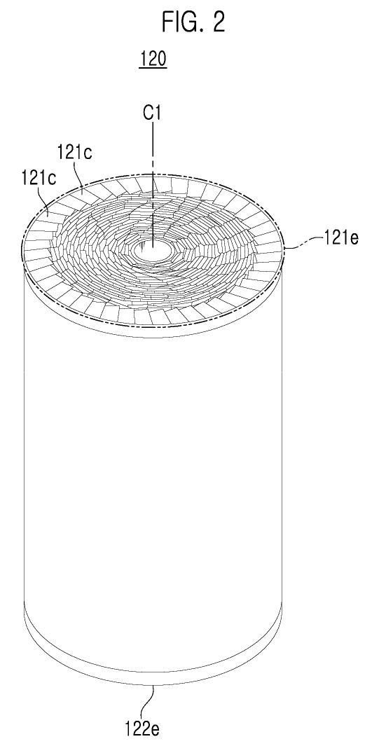

FIG. 2 is a schematic perspective view of an electrode assembly according to one embodiment of the present disclosure.

Referring to FIG. 2, in some embodiments, the secondary battery 100 may include an electrode assembly 120. The electrode assembly 120 may be accommodated in the can 110 as described above. In some embodiments, the electrode assembly 120 may be wound around the central axis C1 and provided in the form of a cylindrical roll. Such a roll-shaped electrode assembly 120 may be referred to as a jelly roll or the like in the art.

In some embodiments, the electrode assembly 120 may include bonding surfaces 121e and 122e at one or both end portions in a direction of the central axis C1. That is, the electrode assembly 120 may include the bonding surfaces 121e and 122e at upper and/or lower end portions, respectively. In the illustrated embodiment, the bonding surfaces 121e and 122e are provided at upper and lower end portions of the electrode assembly 120, respectively. Hereinafter, for convenience, the bonding surface 121e provided at the upper end of the electrode assembly 120 is referred to as a first bonding surface 121e, and the bonding surface 122e provided at the lower end of the electrode assembly 120 is referred to as a second bonding surface 122e.

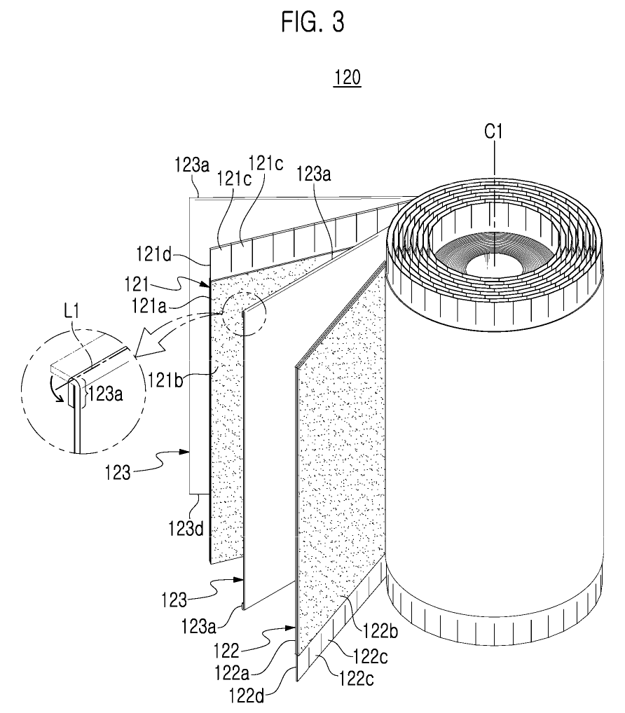

In the above, each of the bonding surfaces 121e and 122e may be formed by bending a plurality of electrode tabs 121c and 122c toward the central axis C1. That is, the first bonding surface 121e may be formed by bending the plurality of first electrode tabs 121c toward the central axis C1 at the upper end of the electrode assembly 120, and the second bonding surface 122e may be formed by bending the plurality of second electrode tabs 122c toward the central axis C1 at the lower end of the electrode assembly 120 (see FIG. 3). In other words, the first bonding surface 121e may be provided as a schematic surface formed by the plurality of bent first electrode tabs 121c, and the second bonding surface 122e may be provided as a schematic surface formed by the plurality of bent second electrode tabs 122c.

In the secondary battery 100, the plurality of electrode tabs 121c and 122c may form the predetermined bonding surfaces 121e and 122e and may be electrically connected to electrode terminals through the bonding surfaces 121e and 122e. That is, in the secondary battery 100, a lead tab is omitted, and each of the bonding surfaces 121e and 122e may replace the function of the lead tab. In some cases, the secondary battery 100 may be referred to as a tabless battery or the like.

In some embodiments, each of the bonding surfaces 121e and 122e as described above may be bonded to a current collector or a cap plate. For example, the first bonding surface 121e may be welded to the current collector at the upper end of the electrode assembly 120, and the second bonding surface 122e may be welded to the other current collector at the lower end of the electrode assembly 120. As another example, the first bonding surface 121e may be welded to the current collector at the upper end of the electrode assembly 120, and the second bonding surface 122e may be welded to the cap plate at the lower end of the electrode assembly 120. Accordingly, each of the bonding surfaces 121e and 122e may be electrically connected to the current collector or the cap plate.

FIG. 3 is a view schematically illustrating a state in which the electrode assembly of FIG. 2 is wound around a central axis.

Referring to FIG. 3, in some embodiments, the electrode assembly 120 may include a first electrode sheet 121 and a second electrode sheet 122 disposed with a separator 123 interposed therebetween. The separator 123 and the first and second electrode sheets 121 and 122 may be wound around the central axis C1. The first electrode sheet 121 may function as a positive electrode or negative electrode, and the second electrode sheet 122 may function as a negative electrode or positive electrode corresponding thereto. In the present description, it is assumed that the first electrode sheet 121 is a positive electrode and the second electrode sheet 122 is a negative electrode.

In some embodiments, the first electrode sheet 121 and the second electrode sheet 122 may respectively include metal foils 121a and 122a wound around the central axis C1, active materials 121b and 122b provided on at least one surface of the metal foils 121a and 122a, and a plurality of electrode tabs 121c and 122c provided in one end portion region of the metal foils 121a and 122a along the direction of the central axis C1 and bent toward the central axis C1. Hereinafter, for convenience, the metal foil 121a, the active material 121b, and the electrode tab 121c corresponding to the first electrode sheet 121 will be referred to as a first metal foil 121a, a first active material 121b, and a first electrode tab 121c, respectively, and the metal foil 122a, the active material 122b, and the electrode tab 122c corresponding to the second electrode sheet 122 will be referred to as a second metal foil 122a, a second active material 122b, and a second electrode tab 122c, respectively.

In some embodiments, the first electrode sheet 121 may include the first metal foil 121a. For example, the first metal foil 121a may include aluminum, stainless steel, nickel, titanium, alloys thereof, or the like. In addition, the first electrode sheet 121 may include the first active material 121b provided on at least one surface of the first metal foil 121a. In some embodiments, the first active material 121b may include a compound capable of reversibly intercalating and deintercalating lithium ions. For example, the first active material 121b may include a lithium-nickel metal oxide, and in some cases, the lithium-nickel metal oxide may include cobalt, manganese, aluminum, and the like.

Similarly, in some embodiments, the second electrode sheet 122 may include the second metal foil 122a. For example, the second metal foil 122a may include copper, stainless steel, nickel, titanium, alloys thereof, or the like. In addition, the second electrode sheet 122 may include the second active material 122b provided on at least one surface of the second metal foil 122a. In some embodiments, the second active material 122b may include a compound capable of reversibly intercalating and deintercalating lithium ions. For example, the second active material 122b may include a carbon-based material such as crystalline carbon, amorphous carbon, carbon composites, and carbon fibers. Alternatively, the second active material 122b may include lithium metal, a lithium alloy, a silicon-containing material, a tin-containing material, or the like.

The separator 123 may be provided between the first electrode sheet 121 and the second electrode sheet 122. The separator 123 may be provided to limit an electrical short circuit between the first and second electrode sheets 121 and 122 and generate the flow of ions. In some embodiments, the separator 123 may include a porous polymer film, a porous nonwoven fabric, or the like. For example, the porous polymer film may include a polyolefin-based polymer such as an ethylene polymer, a propylene polymer, an ethylene/butene copolymer, an ethylene/hexene copolymer, and an ethylene/methacrylate copolymer. In addition, the porous nonwoven fabric may include high melting point glass fibers, polyethylene terephthalate fibers, and the like.

Meanwhile, in some embodiments, the first electrode sheet 121 may include the first electrode tab 121c. In the illustrated embodiment, the first electrode tab 121c is provided at an upper end portion of the first electrode sheet 121. As described above, a plurality of first electrode tabs 121c may be provided, and the plurality of first electrode tabs 121c may be disposed in a direction in which the first electrode sheet 121 is wound. In addition, the first electrode tab 121c may be provided in an upper end region of the first metal foil 121a in which the first active material 121b is not applied. In other words, the first electrode sheet 121 may include a first uncoated portion 121d on which the first active material 121b is not applied, and the first electrode tab 121c may be provided in the first uncoated portion 121d.

Similarly, in some embodiments, the second electrode sheet 122 may include the second electrode tab 122c. In the illustrated embodiment, the second electrode tab 122c is provided at a lower end portion of the second electrode sheet 122. The second electrode tab 122c may be provided in a second uncoated portion 122d on which the second active material 122b is not applied, and a plurality of electrode tabs 122c may be provided.

Meanwhile, the separator 123 may be provided between the first electrode sheet 121 and the second electrode sheet 122 as described above. In some embodiments, an upper end portion of the separator 123 may be disposed between the first electrode tab 121c and an upper end of the second electrode sheet 122. The upper end portion of the separator 123 may function to electrically insulate the first electrode tab 121c from the second electrode sheet 122. Similarly, a lower end portion of the separator 123 may be disposed between a lower end of the first electrode sheet 121 and the second electrode tab 122c. The lower end portion of the separator 123 may function to electrically insulate the first electrode sheet 121 and the second electrode tab 122c from each other.

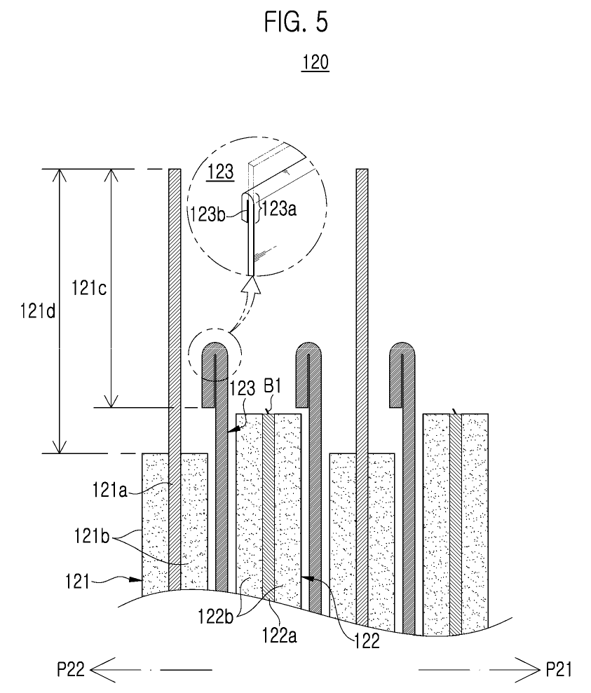

In some embodiments, the separator 123 as described above may include an overlap region 123a. The overlap region 123a may be provided in one or both end portion regions of the separator 123 along the direction of the central axis C1. For example, in the illustrated embodiment, the overlap regions 123a are provided in the upper and lower end portion regions of the separator 123, respectively. The overlap region 123a will be further described with reference to FIG. 5, and the like.

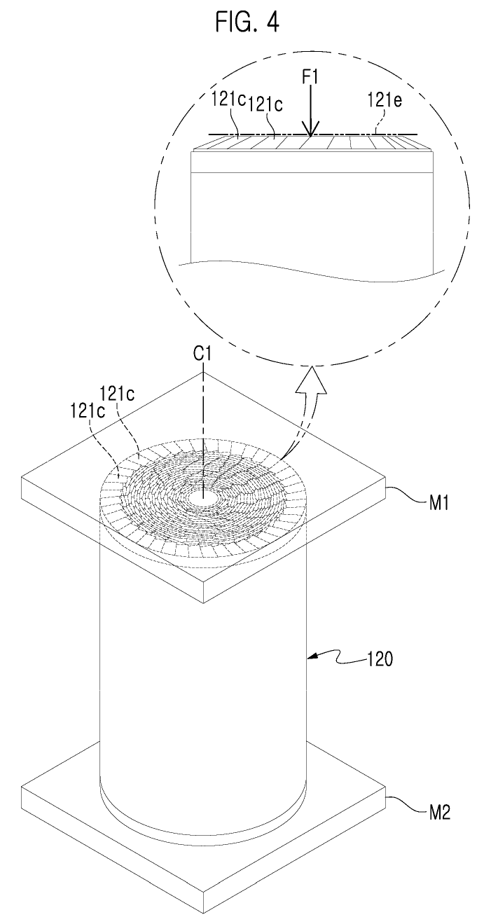

FIG. 4 is a view illustrating a state in which electrode tabs at upper and lower ends in the wound electrode assembly illustrated in FIG. 3 have undergone a flattening process.

Referring to FIG. 4, the electrode assembly 120 wound as shown in FIG. 3 may undergo a flattening process in which the first and second electrode tabs 121c and 122c are bent toward the central axis C1 and the bent first and second electrode tabs 121c and 122c are pressed up and down. In the flattening process, the first and second electrode tabs 121c and 122c may be pressed (F1) through predetermined pressing devices M1 and M2, respectively, thereby causing the first and second electrode tabs 121c and 122c to form the first and second bonding surfaces 121e and 122e as shown in FIG. 2. Thereafter, a current collector, a cap plate, or the like may be appropriately bonded to the first and second bonding surfaces 121e and 122e. For example, a current collector may be disposed on the first bonding surface 121e, and the current collector may be welded to the first bonding surface 121e by laser welding.

FIG. 5 is a schematic view illustrating an enlarged upper end portion of the electrode assembly illustrated in FIG. 3.

For convenience of description, FIG. 5 slightly exaggerates only some components such as the separator 123 at an upper end portion of the electrode assembly 120. In addition, the direction indicated by the right arrow P21 in FIG. 5 represents a radially inward direction, and the direction indicated by the left arrow P22 represents a radially outward direction.

Referring to FIG. 5, in some embodiments, the secondary battery 100 may include a can 110 and an electrode assembly 120 accommodated in the can 110 and formed by winding first and second electrode sheets 121 and 122 disposed with a separator 123 interposed therebetween around a central axis C1. Here, the separator 123 may include an overlap region 123a in one or both end portion regions along the central axis C1.

Specifically, in some embodiments, the secondary battery 100 may include the can 110 and the electrode assembly 120. The can 110 and the electrode assembly 120 may be provided in the same or similar manner as described above.

In some embodiments, the electrode assembly 120 may include the separator 123 and the first and second electrode sheets 121 and 122. The first electrode sheet 121 may include a first metal foil 121a and a first active material 121b, and the first active material 121b may be provided on at least one surface of the first metal foil 121a. In the illustrated embodiment, the first active materials 121b are provided on both surfaces of the first metal foil 121a. Similarly, the second electrode sheet 122 may include a second metal foil 122a and a second active material 122b, and the second active material 122b may be provided on at least one surface of the second metal foil 122a. In the illustrated embodiment, the second active materials 122b are provided on both surfaces of the second metal foil 122a.

In some embodiments, the first electrode sheet 121 may include a first electrode tab 121c. In the illustrated embodiment, the first electrode tab 121c is provided at a partial region of the upper end portion of the first electrode sheet 121. The first electrode sheet 121 may include a first uncoated portion 121d on which the first active material 121b is not applied, and the first electrode tab 121c may be provided as a partial region of the first uncoated portion 121d. In other words, the first uncoated portion 121d may have a predetermined height downward from the upper end of the first electrode sheet 121, and the first electrode tab 121c may have a height that is lower than the predetermined height from the upper end of the first electrode sheet 121 by a predetermined extent.

In some embodiments, the upper end of the second electrode sheet 122 may be disposed at a position higher than the upper end of the first active material 121b by a predetermined extent. This may be implemented by appropriately arranging the positions of the first and second electrode sheets 121 and 122 during the winding process of the first and second electrode sheets 121 and 122 (see FIG. 3).

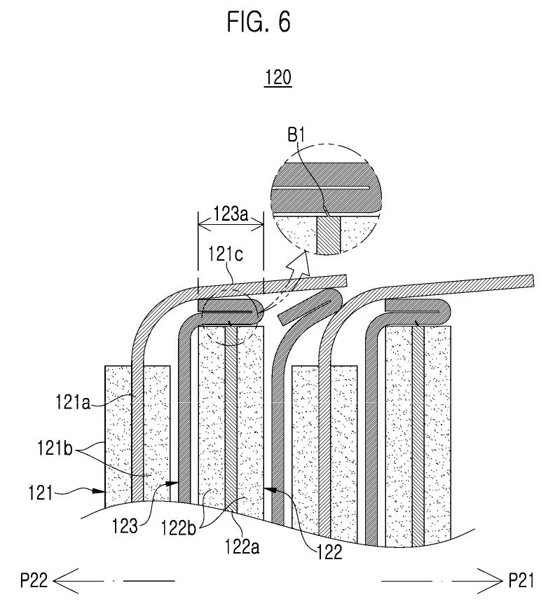

In some embodiments, the separator 123 may extend between the first and second electrode sheets 121 and 122 to a position that is higher than the upper end of the second electrode sheet 122 by a predetermined extent. In other words, the upper end of the separator 123 may be disposed at a position that is higher than the upper end of the second electrode sheet 122 by a predetermined extent. Accordingly, the separator 123 may be bent toward the upper end of the second electrode sheet 122 to cover the upper end of the second electrode sheet 122. For reference, FIG. 5 illustrates a state before the first electrode tab 121c is bent, and a state in which the first electrode tab 121c is bent is also illustrated in FIG. 6 to be described below.

In the above, the separator 123 may include the overlap region 123a in one or both end portion regions along the direction of the central axis C1. In other words, in the illustrated embodiment, the separator 123 may include the overlap region 123a in the upper end region and/or the lower end region. Referring to FIG. 3, in the above-described embodiment, the separator 123 includes the overlap regions 123a in the upper end region and the lower end region, respectively, and in FIG. 5, the overlap region 123a provided in the upper end region is enlarged and illustrated.

In some embodiments, the overlap region 123a may be provided by folding a portion of the separator 123 in an end portion region of the separator 123. That is, when described based on the illustrated embodiment, the overlap region 123a may be folded so that a partial region of the upper end of the separator 123 overlaps another partial region of the lower side. This method may effectively prevent damage to the separator 123 as described below while reducing an additional processing process.

In some embodiments, the overlap region 123a may have a different thickness from other regions of the separator 123. That is, the overlap region 123a may be provided by overlapping the separator 123 as described above, and thus the overlap region 123a may have a thickness that is greater than those of other regions (non-overlapping regions) of the separator 123 by a predetermined extent. In some embodiments, the thickness of the overlap region 123a may be appropriately adjusted by increasing or decreasing the number of overlaps of the separator 123 as described below.

In some embodiments, the overlap region 123a may be provided to be folded along a transverse folding line L1 in which a portion of the separator 123 is perpendicular to the central axis C1 (see FIG. 3). That is, the separator 123 may be provided in the form of a flat sheet without an overlap region 123a, and the end portion region may be folded along the folding line L1 in the transverse direction during the processing process to form the overlap region 123a. The overlap region may be formed in advance before the separator 123 is wound with the electrode assembly 120, or may be continuously formed together with a winding operation while the separator 123 is wound with the electrode assembly 120.

In some embodiments, the overlap region 123a may be provided by bonding the folded portion of the separator 123 to another portion of the separator 123. That is, the folded partial region of the separator 123 may be bonded to another partial region of the separator 123 through an adhesive layer 123b. This may help to properly maintain the overlapping structure of the overlap region 123a. For example, in the overlap region 123a located in the radially inward direction of the electrode assembly 120 having a relatively small curvature, the adhesive layer 123b as described above may help maintain the overlapping structure of the overlap region 123a. In addition, the adhesive layer 123b may help maintain the overlapping structure of the overlap region 123a in accordance with the specific material, thickness, and elasticity of the separator 123.

FIG. 6 is a schematic view illustrating a state in which the electrode tab in the electrode assembly illustrated in FIG. 5 is bent.

Referring to FIG. 6, each of the electrode tabs 121c and 122c in the electrode assembly 120 wound as shown in FIG. 5 may be bent. That is, the electrode assembly 120 may be wound in a state in which each of the electrode tabs 121c and 122c is unfolded as shown in FIG. 3, and then, as shown in FIG. 4, each of the electrode tabs 121c and 122c may be bent toward the central axis C1. FIG. 5 illustrates the electrode assembly 120 in the state corresponding to FIG. 3, and FIG. 6 illustrates the electrode assembly 120 in the state corresponding to FIG. 4.

Specifically, focusing on the illustrated embodiment, the first electrode tab 121c may be bent toward the central axis C1. Accordingly, the overlap region 123a of the upper end of the separator 123 may also be bent together by coming into contact with the first electrode tab 121c. In some embodiments, the bent overlap region 123a may be disposed between the electrode tab 121c provided in one end portion region of the first electrode sheet 121 and one end portion of the second electrode sheet 122. That is, in the illustrated embodiment, the overlap region 123a may be disposed between the first electrode tab 121c and the upper end of the second electrode sheet.

In some embodiments, the overlap region 123a may be provided to be bent toward one end portion of the second electrode sheet 122 to cover the one end portion of the second electrode sheet 122. That is, in the illustrated embodiment, the overlap region 123a may be bent toward the upper end of the second electrode sheet 122 by the bending of the first electrode tab 121c. Accordingly, the overlap region 123a may be disposed to cover the upper end of the second electrode sheet 122.

The overlap region 123a disposed as described above may contribute to more completely separating the first electrode tab 121c and the end portion of the second electrode sheet 122. For example, in the illustrated embodiment, a burr B1 may be generated on the upper end of the second electrode sheet 122 in some cases. The burr B1 may include a sharp protrusion and the like generated at the end portion of the second metal foil 122a in the process of cutting the second electrode sheet 122. The burr B1 may come into contact with the bent separator 123, thereby causing damage to the separator 123. In addition, the damaged separator 123 may cause a short circuit or leakage current between electrodes, thereby degrading the performance of the secondary battery 100. In the illustrated embodiment, damage to the separator 123 due to the burr B1 may be effectively prevented by the overlap region 123a. That is, the overlap region 123a may be provided by overlapping the separator 123 and may have a greater thickness than other regions of the separator 123, thereby effectively preventing damage to the separator 123 due to the burr B1.

In addition, in some embodiments, the overlap region 123a as described above may function to prevent damage to the separator 123 due to welding heat. Specifically, in the illustrated embodiment, the current collector, etc. may be disposed in contact with the upper portion of the first electrode tab 121c and may be welded to the first electrode tab 121c by an external heat source. Here, the overlap region 123a may be disposed with a relatively thick thickness between the first electrode tab 121c and the upper end of the second electrode sheet 122, which may reduce the likelihood of breakage due to welding heat. Accordingly, insulation breakdown during the welding process may be effectively prevented.

In addition, in some embodiments, the overlap region 123a as described above may function to prevent damage or insulation breakdown of the separator 123 due to external forces, vibrations, and the like applied from the external environment while the secondary battery 100 is used.

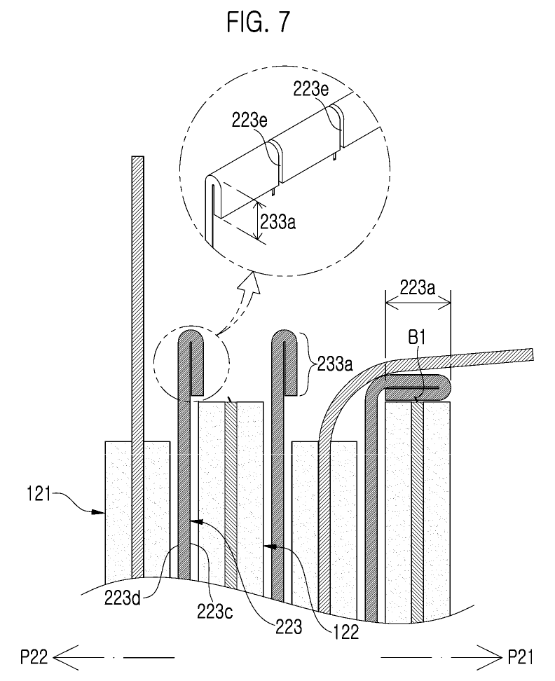

FIG. 7 is a schematic view illustrating another embodiment of the separator illustrated in FIG. 5.

In some embodiments, the overlap region may be provided such that one end portion region of the separator is folded radially inward or radially outward. FIG. 5 illustrates a case in which the upper region of the separator 123 is folded radially outward, and FIG. 7 illustrates a case in which an upper region of a separator 223 is folded radially inward.

Specifically, referring to FIG. 7, the separator 223 may include an inner surface 223c and an outer surface 223d. The separator 223 may have a predetermined thickness between the inner surface 223c and the outer surface 223d. The inner surface 223c of the separator 223 may be disposed radially inward toward the central axis C1. In addition, the outer surface 223d of the separator 223 may be disposed radially outward opposite to the central axis C1 (see FIG. 3).

In the above, an overlap region 223a may be provided such that one end portion region of the separator 223 is folded toward the inner surface 223c or the outer surface 223d. That is, the overlap region 223a may be provided such that the upper end region of the separator 223 is folded toward the outer surface 223d as shown in FIG. 5, or the upper end region of the separator 223 may be folded toward the inner surface 223c as shown in FIG. 7. Both have different folding directions of the separator 223, but may generally provide the same or similar effects as described above.

Meanwhile, in some embodiments, the overlap region 223a may have a cutting line 223e. The cutting line 223e may be provided by partially cutting the overlap region 223a into the form of a slit, a notch, or the like. A plurality of cutting lines 223e may be provided, and the plurality of cutting lines 223e may be spaced apart from each other at predetermined intervals along the overlap region 223a. The plurality of cutting lines 223e may be spaced apart from each other in the winding direction as the separator 223 is wound around the central axis C1. That is, the plurality of cutting lines 223e may be spaced apart from each other at predetermined intervals in the winding direction. The cutting line 223e assists the overlap region 223a to be more smoothly bent toward the central axis C1.

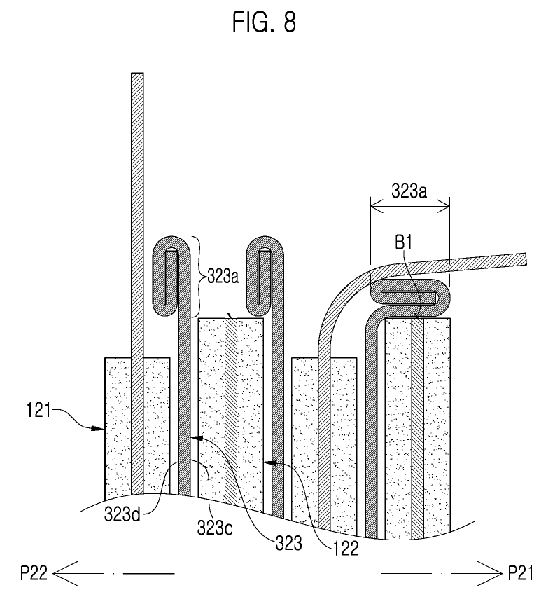

FIG. 8 is a schematic view illustrating still another embodiment of the separator illustrated in FIG. 5.

Referring to FIG. 8, in some embodiments, an overlap region 323a may be formed by overlapping a portion of a separator 323 in a plurality of overlapping layers in the thickness direction in the end portion region of the separator 323. For example, the separator 323 may be provided to be continuously folded a plurality of times toward an outer surface 323d or an inner surface 323c in the end portion region, and accordingly, the overlap region 323a may be provided to overlap a plurality of times in the thickness direction. In the illustrated embodiment, the separator 323 is folded twice toward the outer surface 323d, and accordingly, the overlap region 323a is provided with three overlapping layers. However, the number of overlapping layers in the overlap region 323a may be appropriately increased or decreased as needed, and is not limited thereto. In some embodiments, the number of overlapping layers in the overlap region 323a may be appropriately selected depending on the material, thickness, and the like of the separator 323.

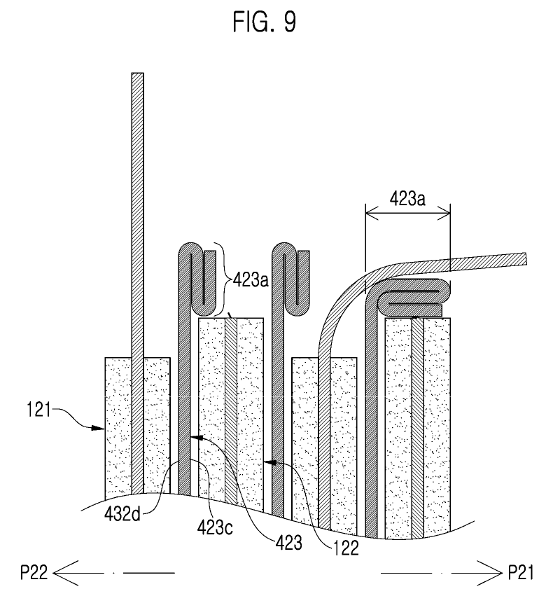

FIG. 9 is a schematic view illustrating yet another embodiment of the separator illustrated in FIG. 5.

Referring to FIG. 9, in some embodiments, an overlap region 423a may be provided by alternately and repeatedly folding a portion of a separator 423 radially inward and outward in the end portion region of the separator 423. For example, the separator 423 may be folded toward an inner surface 423c in the end portion region and then folded again toward an outer surface 423d. The separator 423 may be alternately and repeatedly folded toward the inner surface 423c and the outer surface 423d in this manner. In addition, the folded separator 423 may form the overlap region 423a including a plurality of overlapping layers in the thickness direction. The illustrated embodiment illustrates the overlap region 423a that is folded once toward the inner surface 423c and folded once toward the outer surface 423d. However, the number of overlapping layers in the overlap region 423a may be appropriately increased or decreased as needed, and is not limited thereto. In some embodiments, the number of overlapping layers in the overlap region 423a may be appropriately selected depending on the material, thickness, and the like of the separator 423.

As described above, embodiments of the present disclosure may provide a secondary battery.

In addition, some embodiments of the present disclosure may be implemented as a tabless battery in which a lead tab is omitted and each bonding surface is directly bonded to a current collector or the like.

In addition, in some embodiments of the present disclosure, an overlap region may be provided at the end portion of the separator, and the overlap region may be disposed at the end portion of another adjacent electrode sheet. The overlap region may function to prevent damage to the separator due to burrs, welding heat, and the like during the secondary battery manufacturing process. In addition, the overlap region may function to prevent damage to the separator from external forces, vibrations, etc. applied from the external environment while using the secondary battery.

In addition, in some embodiments of the present disclosure, the end portion region of the separator may be partially folded to provide an overlap region as described above. This may contribute to reducing additional processing processes despite the addition of the overlap region. Accordingly, convenience in manufacturing or processing the secondary battery may be maintained.

Embodiments of the present disclosure can provide a secondary battery.

In addition, some embodiments of the present disclosure can provide a tabless battery in which a lead tab is omitted, and each bonding surface is directly bonded to a current collector or the like.

In addition, some embodiments of the present disclosure can prevent damage to the separator due to burrs, welding heat, or the like during manufacturing, or damage to the separator due to external forces, vibrations, or the like applied from the external environment during use.

In addition, some embodiments of the present disclosure can maintain convenience in manufacturing or processing despite the addition of an overlap region.

The above description is only an example in which the principle of the present disclosure is applied, and other configurations may be further included without departing from the scope of the present disclosure.

Although the embodiments of the present disclosure have been described above, those with ordinary knowledge in the art will be able to modify or change the present disclosure in various ways by adding, changing, deleting, or adding components to the scope of the present disclosure within the scope of the present disclosure.

What is claimed is:

1. A secondary battery comprising:
a can; and
an electrode assembly which is accommodated inside the can and includes first and second electrode sheets disposed with a separator interposed therebetween that are wound around a central axis,
wherein the separator includes an overlap region at one or both end portion regions in a direction of the central axis.

2. The secondary battery of claim 1, wherein the overlap region is provided by folding a portion of the separator in the end portion region.

3. The secondary battery of claim 2, wherein the overlap region is provided by folding a portion of the separator along a transverse folding line perpendicular to the central axis.

4. The secondary battery of claim 2, wherein the overlap region is provided by bonding the folded portion of the separator to another portion of the separator.

5. The secondary battery of claim 1, wherein the overlap region is formed by overlapping a portion of the separator in a plurality of overlapping layers in a thickness direction in the end portion region.

6. The secondary battery of claim 1, wherein the overlap region is disposed between an electrode tab provided in one end portion region of the first electrode sheet and one end portion of the second electrode sheet.

7. The secondary battery of claim 6, wherein the overlap region is provided to be bent toward one end portion of the second electrode sheet to cover the end portion.

8. The secondary battery of claim 1, wherein the overlap region is provided such that a portion of the separator is folded radially inward or radially outward in the end portion region.

9. The secondary battery of claim 1, wherein the overlap region is provided such that a portion of the separator is continuously folded radially inward or radially outward a plurality of times in the end portion region.

10. The secondary battery of claim 1, wherein the overlap region is provided such that a portion of the separator is alternately and repeatedly folded radially inward or radially outward in the end portion region.

11. The secondary battery of claim 1, wherein the overlap region includes cutting lines at predetermined intervals in a winding direction around the central axis.

12. The secondary battery of claim 1, wherein the can is provided in a cylindrical shape with a predetermined diameter and height.

13. The secondary battery of claim 1, wherein the electrode assembly includes a bonding surface at one or both end portions along the central axis direction, and
the bonding surface is provided with a plurality of electrode tabs disposed in a circumferential direction and bent toward the central axis.

14. The secondary battery of claim 13, wherein the bonding surface is welded to a current collector or a cap plate.

15. The secondary battery of claim 1, wherein the first electrode sheet or the second electrode sheet includes:
a metal foil wound around the central axis;
an active material provided on at least one surface of the metal foil; and
a plurality of electrode tabs provided in one end portion region of the metal foil in the central axis direction and bent toward the central axis.
